(19) United States
(12) Patent Application Publication
(10) Pub. No.: US 2014/0279012 A1
(43) Pub. Date: Sep. 18, 2014

(54) TARGETED ADVERTISEMENTS FOR TRAVEL REGION DEMOGRAPHICS

(71) Applicant: INRIX Inc., Kirkland, WA (US)

(72) Inventors: Christopher L. Scofield, Seattle, WA (US); Dominic Jordan, Manchester (GB); Uri Lavee, Tel Aviv (IL); Timothy David McHugh, Stockport (GB); Kevin James Foreman, Sammamish, WA (US); William Schwebel, Seattle, WA (US); Kenneth Kranseler, Bellevue, WA (US)

(21) Appl. No.: 13/843,904

(22) Filed: Mar. 15, 2013

(51) Int. Cl. G06Q 30/02

(52) U.S. Cl. CPC G06Q 30/0269; G06Q 30/0261
USPC 705/14.58

(57) ABSTRACT

For an advertisement opportunity near a travel region, advertisements may be selected that are targeted to individuals who are likely to view the advertisement. However, travel patterns among individuals sharing particular traits may exist that facilitate targeted advertising, but may be non-intuitive and therefore difficult to predict, and other techniques, such as population surveys, may be costly and inaccurate. Presented herein are techniques for automatically evaluating travel patterns by tracking the routes of particular individuals, and inferring demographics for such individuals based on the locations of their routes (e.g., an individual whose route frequently includes a residence may be presumed to share the population demographics of the residential neighborhood). Extrapolating such individual demographics may enable inference of shared demographics at particular advertisement opportunities (e.g., among travelers who frequently travel on a particular road at a particular time of day) and the selection of advertisements more closely targeting such individuals.

### BACKGROUND

Within the field of computing, many scenarios involve targeted advertisements presented at various advertisement opportunities relating to a travel region, such as a billboard placed next to a highway. In such scenarios, it may be desirable to present targeted advertisements that are of interest to the individuals who are likely to pass by the advertisement opportunity. For example, advertisements for travel opportunities, such as tourist destinations, may be appealing to travelers on a long stretch of highway, while advertisements of local interest, such as news reports of local weather forecasts, may be appealing to individuals caught in rush-hour traffic, who are more likely to be local residents. In this manner, it may be desirable to identify traits relating to the individuals who are likely to view an advertisement opportunity, and to present targeted advertisements relating to those traits.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While it may be advantageous to predict or estimate the traits of individuals who are likely to travel in a travel region, it may be difficult to identify the particular demographics of such individuals. For example, for a billboard near a sports arena, it may be reasonable to predict that travelers in the area are interested in sports events, and to present targeted advertisements relating to such individuals; however, it may be difficult to predict with high confidence any further traits of such individuals, such as age, gender, race, income, or other interests. Nevertheless, demographic trends may exist among such travelers, and it may be advantageous to identify such shared demographics in order to present more highly tailored advertisements. For example, a set of individuals may travel near the sports arena at a particular time of day en route to another nearby location, such as a grade school, and advertisements relating to academics or families may be highly persuasive to such individuals if presented at this time of day. However, such trends among such travelers may be difficult to predict, and traditional techniques for detecting such trends (e.g., population surveys) may be costly, cumbersome, and/or inaccurate.

Presented herein are techniques for identifying the demographics of particular sets of individuals who may be traveling in a travel region (e.g., along a particular road) that is near an advertisement opportunity. In accordance with these techniques, it may be possible to use automated techniques to track individual travelers, and to estimate a route of the individual traveler, such as a starting location, a destination, and one or more visited locations along the route. As a first example, such individuals often carry mobile devices, such as mobile phones, laptops, tablets, and global positioning system (GPS) devices, and a set of fixed communication devices that communicate with such devices (e.g., cellular network towers and Wi-Fi routers) may communicate with the device of a particular individual and may be able to track the route of the user. As a second example, a set of traffic cameras with optical character recognition (OCR) components may respectively identify a license plate of a vehicle of the user. In view of the route of the individual and the locations visited along the route by the individual, an embodiment of these techniques may identify a demographic of the individual; e.g., if the route of an individual begins or ends at a residence in a particular neighborhood, it may be inferred that the individual resides in the neighborhood, and may therefore match the shared demographics of residents of the neighborhood.

Applying such inferences for a large number of individuals in a particular travel region may enable an extrapolated inference of the demographics of individuals who travel in the travel region. For example, if a significant number of individuals who travel on a particular road at a particular time of day, such as Mondays at 8:30 A.M., are detected or inferred to leave from a particular neighborhood, targeted advertisements may be selected for advertisement opportunities for the travel region that are targeted to the shared demographics of residents of the neighborhood. Such detection may be performed more efficiently, and may yield results that are more detailed, accurate, and/or non-intuitive, than techniques such as traffic surveys.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring an advertisement presented at an advertisement opportunity to individuals in a travel region.

FIG. 2 is an illustration of an exemplary scenario featuring a tracking of individuals in a travel region and an estimation of routes and locations of such individuals.

FIG. 3 is an illustration of an exemplary scenario featuring a selection of advertisements targeting individuals in particular travel regions based on an inference of shared demographics among such individuals in accordance with the techniques presented herein.

FIG. 4 is a flow diagram illustrating an exemplary method of selecting advertisements for advertisement opportunities near travel regions in accordance with the techniques presented herein.

FIG. 5 is a component block diagram of an exemplary system for selecting advertisements for advertisement opportunities near travel regions in accordance with the techniques presented herein.

FIG. 6 is an illustration of an exemplary computer-readable medium comprising processor-executable instructions configured to embody one or more of the provisions set forth herein.

FIG. 7 is an illustration of an exemplary scenario featuring a near-realtime selection of advertisements based on a inference of shared demographics of individuals currently traveling near an advertisement opportunity.

FIG. 8 is an illustration of an exemplary scenario featuring a mapping of targeted advertisements to advertisement opportunities based on the inference of shared demographics of individuals in travel regions near such advertisement opportunities.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. INTRODUCTION

FIG. 1 presents an illustration of an exemplary scenario 100 featuring a travel region 102 (e.g., a highway segment) where a set of individuals 104 are traveling in a set of vehicles 106. In such scenarios, some of the individuals 104 may possess a communications device 108, such as a mobile phone, a tablet, or a global positioning system (GPS) receiver, that may establish a connection 110 with one or more stationary communications devices 112, such as cellular network towers or a Wi-Fi receivers. Additionally, an advertisement opportunity 116 may be positioned near the travel region 102 and may be viewable by individuals 104 traveling in the travel region 102, such as a billboard positioned near a highway, or a store front sign or banner positioned near a roadway. A set of advertisements 114 may be selected for presentation at the advertisement opportunity 116, such as advertisements for nearby restaurants or other businesses.

In such scenarios, it may be advantageous to select advertisements 114 that are likely to appeal to the particular individuals 104 who may view the advertisements 104. As a first example, it may be presumed that a road near a sports stadium may often be traveled by individuals 104 who are interested in sports, particularly at times near sporting events occurring at the sports stadium. For an advertisement opportunity 116 positioned near the sports stadium, it may be advantageous to present advertisements 114 relating to sports and to correlational interests of such individuals 104. As a second example, an advertisement opportunity 116 near a set of offices may be viewable during rush hour by individuals 104 trapped in traffic in the travel region 102, many of whom may comprise local residents of the area who are employed in the offices, and who are interested in local news, such as local weather forecasts. As a third example, an advertisement opportunity 116 near an airport may be presumably viewed by individuals 102 traveling to the airport who are interested in travel-related products and services. In this manner, targeted advertising techniques may be applied to select advertisements 114 having a greater persuasive effect on the individuals 104.

However, in many such scenarios, additional traits may exist among individuals 104 traveling in a particular travel region 102 that are difficult to predict, as such traits may be non-intuitive. For example, the road past the sports stadium may be an efficient route between a particular neighborhood and a particular grade school, and at a specific time of day (e.g., just before the start of school each weekday morning, and just after the end of school each weekday afternoon). Individuals 104 traveling in this travel region 102 at these times of day may share some demographic traits that may facilitate targeted advertisements. However, it may be difficult to predict this traffic pattern, as these shared demographics may be non-intuitive (e.g., the school may not be anywhere near the sports stadium), and occasionally even counterintuitive (e.g., students and parents of the school may actually be averse to sporting events). Some techniques may exist for detecting such patterns, such as population surveys of travelers in the area, but such techniques may be costly and/or ineffective (e.g., such individuals may decline to participate in such population surveys), or may simply not be possible (e.g., it may be difficult to survey individuals 104 traveling through the travel region 102 and not typically stopping there). Accordingly, such traffic patterns and demographic trends may be undetectable by such techniques, and therefore unavailable for targeted advertising.

### B. PRESENTED TECHNIQUES

Presented herein are techniques for automatically identifying shared demographics among individuals traveling in a particular travel region 102. In accordance with such techniques, some automated techniques may be utilized to track the routes of specific individuals 104 through the travel region 102. As a first example, individuals 104 who carry communications devices 108 may be tracked by one or more stationary communications devices 112 with which such communications devices 108 establish a connection 110 (e.g., tracking a mobile phone according to the cellular network towers to which the mobile phone connects while the individual 104 travels). As a second example, individuals 104 may operate a vehicle 106 that is automatically identifiable, such as traffic cameras equipped with optical character recognition (OCR) techniques that are capable of reading and tracking a particular license plate as the individual 104 drives through a travel region 102. Additionally, automated techniques may identify one or more locations along the route visited by the specific individuals 104 (e.g., inferring an origin of the individual 104 based on the first detected location of the individual 104; a destination of the individual 104 based on the last detected location of the individual 104 and/or the route selected by the individual 104; and intermediate visited locations based on detected periods when the individual 104 is stationary, or time gaps between nearby detected locations). For such visited locations, demographic information may be available as to the types of individuals who visit the location; e.g., an individual who visits a particular residential location may be presumed to share the demographics of the population of the residential neighborhood. Accordingly, for the particular individuals whose routes have been tracked, a demographic may be inferred. Extrapolating individual inferences may enable inferences as to the shared demographics of an entire population of individuals 104 who often travel in a travel region 102 (e.g., traits shared by the population of travelers along a particular highway at 8:30 A.M. each Monday morning), and may enable the selection of advertisements that are more closely targeted to such individuals 104.

FIG. 2 presents an illustration of an exemplary scenario 200 featuring an automated tracking of individuals 104 in a travel region 102, such as along a particular roadway at particular time of day 202. At a first time point 200 occurring at a first time of day 202, among a first set of individuals 104, respective individuals 104 may be automatically tracked and identified as traveling a particular route 206 having an origin 204 and a destination 208 (e.g., a set of individuals 104 each departing from origins 204 within a particular first neighborhood, and traveling to destinations 208 comprising office buildings in a particular area of the city). At a second time point 210 occurring at a second time of day 202, among a second set of individuals 104, respective individuals may be automatically tracked and identified as traveling a particular route 206 (e.g., a set of individuals 104 each departing from origins 204 in a particular second neighborhood, and traveling to a destination 208 comprising a school serving the neighborhood). At a third time point 212 occurring at a third time of day 202, among a third set of individuals 104, respective individuals maybe automatically tracked and identified as traveling a particular route 206 (e.g., departing from an origin 204 comprising a particular business 204, and traveling to destinations 208 in a particular third neighborhood).

FIG. 3 presents an illustration of an exemplary scenario wherein the use of such automatically tracked routes 206 of such individuals 104. In this exemplary scenario, a demographics map 300 may be utilized, wherein, for particular locations 302, a demographic 304 of individuals 104 who frequently visit the location 302 may be identified. As a first example, for respective neighborhoods, a set of demographics 304 may be identified for individuals 104 residing in the neighborhood, such as the average ages, genders, races, income brackets, and interests of such individuals 104. As a second example, for respective offices, a set of demographics 304 may be identified for individuals 104 who are employed in such offices, and/or for the clientele of such offices. As a third example, for respective establishments such as schools or restaurants, a set of demographics 304 may be identified for the population of individuals 104 who are enrolled in such schools and who frequent such restaurants.

As further illustrated in the exemplary scenario of FIG. 3, a matching 306 may be performed between the inferences as to the routes 206 of individuals 104 tracked in a travel region 102, including the locations 304 visited by such individuals 104 (as in the exemplary scenario 200 of FIG. 2), and the demographics map 302 indicating the demographics of individuals 104 visiting such locations 304, to produce an automated inference of the shared demographics 308 of individuals 104 traveling in the travel region 102. Additionally, such matching 306 may enable an automated selection of advertisements 114 for presentation at an advertisement opportunity 116 in the travel region 102. As a first example, the individuals 104 traveling at a particular first time of day 202 from the first neighborhood (associated in the demographics map 300 with a first demographic 304) to a particular destination 208 comprising a set of offices (also associated in the demographics map 300 with the first demographic 304) may be inferred as sharing the first demographic 304, e.g., 20-29-year olds who are interested in technology and sports. As a second example, the individuals 104 traveling at a particular second time of day 202 from the second neighborhood (associated in the demographics map 300 with a second demographic 304) to a particular destination 208 comprising a school (also associated in the demographics map 300 with the second demographic 304) may be inferred as sharing the second demographic 304, e.g., 30-49-year olds who are interested in family products and television. As a third example, the individuals 104 traveling at a particular third time of day 202 from a particular restaurant associated in the demographics map 300 with a third demographic 304) to a particular destination 208 comprising the third neighborhood (also associated in the demographics map 300 with the third demographic 304) may be inferred as sharing the third demographic 304, e.g., 50-69-year-olds who are often interested in health products and travel. Accordingly, at a travel opportunity 116 near the travel region 102, advertisements 114 may be selected from an advertisement set 310 based on the shared demographics 308 of a population of travelers, as extrapolated from the tracking of routes 206 of the individuals 104 comprising the population. For example, at a first time of day 202 when many individuals 104 inferred as sharing the first shared demographic 308 travel near the advertisement opportunity 116, advertisements 114 for technology and sports products may be presented at the advertisement opportunity 116; at a second time of day 202 when many individuals 104 inferred as sharing the second shared demographic 308 travel near the advertisement opportunity 116, advertisements 114 for family-related products and television shows may be presented at the advertisement opportunity 116; and at a third time of day 202 when many individuals 104 inferred as sharing the third shared demographic 308 travel near the advertisement opportunity 116, advertisements 114 for health and travel services and may be presented at the advertisement opportunity 116. In this manner, the selection of advertisements 114 for presentation at an advertisement opportunity 116 may be targeted according to the inferred shared demographics 308 of the individuals 104 traveling near an advertisement opportunity 116 in accordance with the techniques presented herein.

### C. EXEMPLARY EMBODIMENTS

FIG. 4 presents a first exemplary embodiment of the techniques presented herein, illustrated as an exemplary method 400 of selecting advertisements 114 for presentation to users 104 at an advertisement opportunity 116 near a travel region 102. The exemplary method 400 may be implemented on a device having a processor and having access to an advertisement set 310. The exemplary method 300 may be implemented, e.g., as a set of instructions stored in a memory component of a device (e.g., a memory circuit, a platter of a hard disk drive, a solid-state memory component, or a magnetic or optical disc) that, when executed by the processor of the device, cause the device to perform the techniques presented herein. The exemplary method 400 begins at 402 and involves executing 404 the instructions on the processor. Specifically, the instructions are configured to, for respective 406 individuals 104 traveling in a travel region 102 having an advertisement opportunity 116, identify 408 a route 206 of the individual 104; identify 410 at least one location 302 visited by the individual 104 along the route 206; and, based on the at least one location 302, identify a demographic 304 of the individual 104. The instructions are also configured to, based on the identification 412 of the demographics 304 of the respective individuals 104, identify 414 a shared demographic 308 of the individuals 104 traveling in the travel region 102. The instructions are also configured to select 416 for presentation at the advertisement opportunity 116 an advertisement 114 targeting the shared demographic 308. In this manner, the exemplary method 400 achieves the selection of advertisements 114 for presentation at the advertisement opportunity 116 near the travel region 102 that are targeted to the shared demographics 308 inferred for the individuals 104 traveling in the target region 102 in accordance with the techniques presented herein, and so ends at 418.

FIG. 5 presents an illustration of an exemplary scenario 500 featuring a second exemplary embodiment of the techniques presented herein, illustrated as an exemplary system 508 for selecting advertisements 114 for an advertisement opportunity 116 near a travel region 102. The exemplary system 508 may be implemented, e.g., on a device 502 having a processor 504 and a memory 506. Respective components of the exemplary system 508 may be implemented, e.g., as a set of instructions stored in a memory 506 of the device 502 and executable on the processor 504 of the device 502, such that the interoperation of the components causes the device 502 to operate according to the techniques presented herein. The exemplary system 508 comprises an individual tracking component 510 configured to, for respective individuals 104 traveling in the travel region 102, identify a route 206 of the individual 104; identify at least one location 302 visited by the individual 104 along the route 206; and, based on the at least one location 302, identify a demographic 304 of the individual 104, thereby producing a route and location set 516 for respective individuals 104. The exemplary system 508 also comprises a demographic mapping component 512 configured to, by comparing the routes 206 and locations 302 for respective individuals 104 with a demographics map 300, identify a demographic 304 of the individual 104; and to identify a shared demographic 308 of the individuals 104 traveling in the travel region 102, thus producing a set of travel region demographics 518. The exemplary system 508 also comprises an advertisement selecting component 514 that is configured to, based on the travel region demographics 518, select for presentation at the advertisement opportunity 104, from an advertisement set 310, targeted advertisement 520 targeting the shared demographics 308 of the individuals 104. In this manner, the components of the exemplary system 508 may interoperate to achieve targeted advertising for the advertisement opportunity 116 based on the shared demographics 308 of the individuals 104 in the travel region 102 in accordance with the techniques presented herein.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

An exemplary computer-readable medium that may be devised in these ways is illustrated in FIG. 6, wherein the implementation 600 comprises a computer-readable medium 602 (e.g., a CD-R, DVD-R, or a platter of a hard disk drive), on which is encoded computer-readable data 604. This computer-readable data 604 in turn comprises a set of computer instructions 606 configured to operate according to the principles set forth herein. In a first such embodiment, the processor-executable instructions 606 may be configured to, when executed by a processor 612 of a device 610, cause the device 610 to perform a method of selecting advertisements 114 for presentation at an advertisement opportunity 116, such as the exemplary method 400 of FIG. 4. In a second such embodiment, the processor-executable instructions 606 may be configured to implement a system for selecting advertisements 114 for presentation at an advertisement opportunity 116, such as the exemplary system 508 of FIG. 5. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. VARIABLE ASPECTS

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 400 of FIG. 4 and the exemplary system 508 of FIG. 5) to confer individual and/or synergistic advantages upon such embodiments.

D1. Scenarios

A first aspect that may vary among embodiments of these techniques relates to the scenarios wherein such techniques may be utilized.

As a first variation of this first aspect, the techniques presented herein may be utilized in many types of travel regions 102 and travel scenarios. As a first such example, the individuals 104 may comprise motorists traveling along a travel region 102 comprising a roadway, and the advertisement opportunities 116 may comprise static or video billboards posted near the roadways; storefront signs, banners, or placards viewable from the roadway; or short-range radio broadcasts receivable by the radios within the automobiles. As a second such example, the travel region 102 may comprise a walking or bicycle path; the individuals 104 may comprise pedestrians and bicyclists using the path; and the advertisement opportunities 116 may comprise signs or kiosks positioned along the path. As a third such example, the travel region 102 may comprise an airplane; the individuals 104 may comprise air passengers; and the advertisement opportunities 116 may comprise video presentations from a seat-back monitor. As a fourth such example, the travel region 102 may comprise a seating area in a high-traffic pedestrian area, such as a park or an indoor or outdoor mall; the individuals 104 may comprise employees or shoppers visiting and briefly stopping in the pedestrian area (e.g., during a lunch break or a visit to a food area of the mall); and the advertisement opportunity 116 may comprise a static or video display presented in the pedestrian area.

As a second variation of this first aspect, the techniques presented herein may involve many types of demographics 304, such as age, gender, race, income bracket and financial status, owned assets, education level, professions or skills, physical capabilities and handicaps, personal views, topical interests, and product and service preferences.

As a third variation of this first aspect, the techniques presented herein may involve many types of advertisements 114 for products and services, such as commodity products; commercial products; niche or luxury products; brands; real estate; persuasive political statements or advertisements; and personal, professional, and/or educational services. Those of ordinary skill in the art may devise many variations in the scenarios in which the techniques presented herein may be utilized, and in the variations of devices and architectures used to achieve the application of the techniques presented herein.

D2. Route and Location Tracking

A second aspect that may vary among embodiments of the techniques presented herein relates to the manner of tracking the routes 206 and/or locations 302 visited by respective individuals 104.

As a first variation of this second aspect, the tracking of routes 206 of individuals 104 may be achieved through a tracking of one or more communication devices 108 carried by such individuals. Such communication devices 108 may include, e.g., mobile phones, tablets, laptops, global positioning system (GPS) devices, in-car navigation or assistance systems, vehicle tracking devices, portable media players, portable game devices, medical devices, and wearable computers, such as glasses-based computers. Such communication devices 108 may be tracked in various ways. As a first such example, a tracking device may have access to a set of communication devices respectively positioned at a location 302, and the route 206 of the individual 104 may be identified by identifying at least two communication devices that respectively communicate with the communication device 106 of the individual 104 at a communication time, and identifying the route 206 from the communication times and the locations of the communication devices communicating with the individual 104. For example, the communication devices 108 may be configured to connect to nearby stationary communication devices, such as cellular network towers, Wi-Fi wireless network devices, or Bluetooth devices, for which a fixed and known location is identifiable. As the device 108 switches among such stationary communication devices, a tracking or triangulation may be performed to identify the location of the communication device 108. As a second such example, the communication devices 108 may simply be configured to report a location of the individual 104 periodically to a server, or to report a route 206 and/or locations 302 selected for visit by the individual 104.

As a second variation of this second aspect, the tracking of routes 206 of individuals 104 may be achieved through various machine vision techniques. As a first example, a stationary or mobile camera may be equipped with optical character recognition (OCR) technology that enables an automated recognition of a license plate or other identifier of the vehicle 106 of the user, and the locations of such cameras at the time of recognizing the vehicle 106 of the individual 104 may reveal the route 206 of the individual 104. As a second example, a stationary or mobile camera may include object recognition techniques that enable an identification and tracking (periodically or continuously) a vehicle 106 of the individual 104 during transit along the route 206. As a third example, a stationary or mobile camera may be equipped with biometric sensors, and may personally identify the individual 104 according to various face, gait, or other biometric recognition techniques.

As a third variation of this second aspect, based on various reported locations of the individual 104, a route 206 and respective locations 302 along the route 206 (including an origin 204 and a destination 208) may be identified in many ways. As a first such example, the individual 104 may simply specify the route 206 and/or locations 302. As a second such example, predictions of the route 206 may be achieved, e.g., based on a matching of the locations 302 along the route 206 and a user profile of the individual 104 (e.g., the individual's personal address, place of employment, and contacts' addresses). As a third such example, predictions of the route 206 may be based on the history of the individual 104 (e.g., previously traveled routes 206 and/or previously visited locations 302), and/or upon the routes 206 and/or locations 302 of other individuals 104 (e.g., locations 302 that other travelers in the same travel region 102 often visit). These and other techniques may be used to identify the route 206 and/or locations 206 of the individuals 104 in accordance with the techniques presented herein.

D3. Demographic Identification

A third aspect that may vary among embodiments of the techniques presented herein relates to the manner of identifying the demographics 304 of respective individuals 104, and the shared demographics 308 that are shared among a set of individuals 104.

As a first variation of this third aspect, the demographics 304 of respective individuals 104 may be identified based on the shared demographics 308 of individuals associated with a particular location 302, such as the demographics of a neighborhood, business, school, or commercial outlet. As a first such example, demographic information may be recorded in a demographics map 300 that identifies a demographic 304 of individuals 104 associated with the location 302. As a second such example, the demographics 304 may be inferred based on the type of location 302 (e.g., a residence of the individual 104; an employment place of the individual 104; a commercial outlet visited by the individual 104; an event site of an event attended by the individual 104; and a neighborhood of a region including the location 302).

As a second variation of this third aspect, other information about the individual 104 may provide demographic information that may supplement the demographics 304 associated with the locations 302. As a first such example, a camera configured to analyze an image of the individual 104 according to various biometric techniques may be capable of identifying or estimating various demographics 304 of the individual, such as age, gender, and race. As a second such example, various aspects of the route 206 of the individual 104 may reveal more information about the relationship between the individual 104 and the location 302; e.g., for a location 302 comprising a hospital, individuals 104 who arrive early may be potentially identified as employees of the hospital and matching the demographics 304 of hospital employees, while individuals 104 who arrive in the middle of the day may be potentially identified as patients of the hospital. As a second such example, various items of metadata about the individual 104 may supplement the identified individual demographics 304, such as a type of vehicle 106 operated by the individual 104; the route 206 of the individual 104 (e.g., the driving style of the individual 204); a type of communication device 108 carried by the individual 104, and/or a device property of the communication device 108 (e.g., a type of mobile phone, or a type of activity performed with the mobile phone); and/or a user selection of the demographic 304 of the individual 104 (e.g., a user profile created by or for the individual 104).

As a third variation of this third aspect, the demographic 304 of respective individuals 104 may be synthesized from the set of demographics 304 associated with two or more locations 302 visited by the individual 104. For example, if the user 104 visits a first location 302 associated with a first demographic 304 and also a second location 302 associated with a second demographic 304 that is different from the first demographic 304, various techniques may be utilized to determine which demographics 304 describe the individual 104 (e.g., by choosing one of the locations 302 based on the number of visits by the individual 104 to each location 302 or the time spent at each location 302, or according to the mean, median, or mode among the conflicting demographics 304).

As a fourth variation of this third aspect, from the demographics 304 of respective individuals 104, a set of shared demographics 308 for the population of individuals 104 may be identified in many ways. As a first such example, the shared demographics 308 may comprise the most frequently identified demographics 304 of the individuals 104 (e.g., the most frequently appearing traits). As a second such example, an embodiment may identify a dominant demographic 304 that is shared by a significant portion of the individuals 104 (e.g., a majority shared demographic 308). As a third such example, the individuals 104 may be grouped into two or more individual groups, each group having a specific set of shared demographics 308 associated with a distinct group having an estimated percentage of the individuals 104 in the travel region 102. As a fourth such example, different shared demographics 308 may be identified for the same travel region 102; e.g., for a particular roadway, different shared demographics 308 may be identified for different times of day 202 (e.g., different ranges of times on any day, or different ranges of times on particular days of the week), and a set of one or more targeted advertisements 520 may be selected for respective advertisement periods matching the times of day 202 when such groups of individuals 104 are traveling in the travel region 102 near the advertisement opportunity 116. In this manner, a particular advertisement opportunity 116 (e.g., a billboard in a particular location) may display a first set of targeted advertisements 520 matching a set of shared demographics 308 of first population of individuals 104 at a first time of day 202, and a second set of targeted advertisements 520 matching a set of shared demographics 308 of first population of individuals 104 at a second time of day 202. These and other techniques may be utilized to identify the shared demographics 308 of the individuals 104 in the travel region 102 in accordance with the techniques presented herein.

D4. Advertisement Selection and Presentation

A fourth aspect that may vary among embodiments of the techniques presented herein relates to the manner of selecting targeted advertisements 520 for presentation at the advertisement opportunities 116 based on the identified shared demographics 308.

As a first variation of this fourth aspect, the selection and presentation of advertisements 114 may be performed with various degrees of timing. For example, targeted advertisements 520 may be pre-planned to be presented at a later time; or the shared demographic 308 of a set of individuals 104 currently traveling in the travel region 102 may be identified, and may promptly result in a presentation of selected targeted advertisements 520 to the individuals 104 while still occupying the travel region 102.

FIG. 7 presents an illustration of an exemplary scenario 700 featuring a presentation of advertisements to a set of individuals 104 traveling along a roadway. In this exemplary scenario, individuals 104 passing a stationary communication device 112 (e.g., a cellular tower) may be provided to a device 702 configured to evaluated to identify the routes 206 and locations 302 of such individuals 104, such as an origin 204 and a destination 208, and to compare such routes 206 and locations 302 with a demographics map 300. Based on this comparison, the device 702 may then select one or more targeted advertisements 520 for presentation at an advertisement opportunity 116 located a short distance down the roadway. In this manner, targeted advertisements 520 may be selected and presented in near-realtime to the individuals 102 traveling in the travel region 102.

As a second variation of this fourth technique, the selection of advertisements may also match various other contextual information related to the individuals 104, the route 206, locations 304 near the route 206, and/or the advertisement opportunities 116. As a first such example, the selection of advertisements 114 for presentation may also target an advertisement period (e.g., the time of day 202 in which the targeted advertisement 520 is to be presented). As a second such example, the selection of advertisements 114 for presentation may also involve an advertised location 304 that is near the routes 206 of the individuals 104 (e.g., a short diversion from the advertisement opportunity 116 or another point along the route 206). As a third such example, the selection of advertisements 114 for presentation may also involve at least one of the locations visited by the individuals (e.g., near an origin 204 or destination 208 of one or more individuals 104). For example, if a group of individuals 104 is determined to be traveling toward a destination 208 where a particular event is being held (e.g., a sports event), advertisements 114 associate with the event may be selected, such as opportunities for products or services related to the event. As a fourth such example, the selection of advertisements 114 for presentation may also target at least one device of the individuals 104 traveling in the travel region 102 (e.g., a type of vehicle 106 operated by one or more individuals 104, or a type of communication device 108 carried by one or more individuals 104). Many such types of contextual and personalized indicators may be included in the targeting of advertisements 114 to the individuals 104 in the travel region 102.

As a third variation of this fourth aspect, the selection of advertisements 114 from an advertisement set 310 may be performed in many ways. As a first such example, a device configured to select advertisements 114 for presentation may identify the shared demographics 308 to an advertiser, and may receive from the advertiser an advertisement targeting individuals 104 having the shared demographics 308. As a second such example, from an accessible advertisement set 310, the device may select a targeted advertisement 520 that is most closely aligned with the shard demographics 308 of the individuals 104. However, this selection may result in the same advertisements 114 being presented repeatedly, and/or particular advertisements 114 not being presented at all. For example, a small but distinct population of individuals 104 may exhibit a strongly correlated shared demographic 308 and may be readily persuaded by targeted advertisements 520, but such individuals 104 may consistently comprise a minority of the individuals 104 in a particular travel region 102, and may therefore not have their shared demographics 308 selected for targeted advertisements 520. Instead, the selection of advertisements 114 from an advertisement set 310 may be performed in reverse; e.g., among a set of advertisement opportunities 116 associated with shared demographics 308 and the advertisements 114 of the advertisement set 310, respective advertisements 114 may be mapped to the advertisement opportunity 116 with the closest matching shared demographic 308 that is most suitable and not yet occupied by another advertisement 114 (e.g., selecting the advertisement opportunity 116 having a highest volume of individuals 102 identified as sharing the shared demographic 308). Additionally, for respective advertisement opportunities 116, a set of targeted advertisements 520 may be selected for presentation that target two or more sets of shared demographics 308 that are associated with two or more groups of individuals concurrently traveling in the travel region 102. Some embodiments may approach the matching of advertisement opportunities 116 and targeted advertisements 520 as a “best fit” problem and/or using various utility maximization models.

FIG. 8 presents an illustration of an exemplary scenario 800 featuring an exemplary matching of targeted advertisements 520 for respective advertisement opportunities 116. In this exemplary scenario 800, among the individuals 104 traveling in one or more travel regions 102 at different times of day 202, the individuals 104 may be divided into subgroups matching different shared demographics 308. Additionally, for respective targeted advertisements 520, a particular advertisement opportunity 116 may be selected that targets the shared demographics 308 of the group of individuals 104 traveling in the travel region 102 at the time of day 202. In this manner, small populations of individuals 104 may be targeted by a targeted advertisement 520 even if such individuals 104 comprise a distinct minority of all of the individuals 104 in the travel region 102 at that time of day 202. Additionally, an advertisement 114 targeting two or more shared demographics 308 may be selected for an advertisement opportunity 116 presenting both shared demographics 308; and/or two or more targeted advertisements 520 may be selected for presentation in the same advertisement opportunity 116 (in a consecutive or concurrent manner).

As a fourth variation of this fourth aspect, various techniques may be used to present the selected advertisements 114 to the individuals 104 in the travel region 102. As a first such example, the advertisements 114 may be displayed in a visual location that is viewable from the travel region 102. As a second such example, the advertisements 114 may be broadcast from a short-range radio transmitter received by a radio of the individuals 104, and/or inserted into regular broadcasts for the individuals 104 in the travel region 102. As a third such example, the advertisements 114 may be transmitted to a communications device 108 operated by such individuals 104 (e.g., inserted into web content retrieved from an individual 104 using a mobile web browser, or transmitted to a static or video display presented within a vehicle 106 of the individual 104). These and other techniques for selecting and presenting the advertisements 114 to the individuals 104 may be utilized in accordance with the techniques presented herein.

D5. Advertisement Engagement

A fifth aspect that may vary among the techniques presented herein relates to the engagement of respective individuals 104 with the advertisements 114 presented at the advertisement opportunity 116.

As a first variation of this fifth aspect, the engagement of respective individuals 104 with an advertisement 114 may be detected in many ways. As a first such example, the advertisement 114 may comprise a uniform resource location (URL) identifying a website with information and offers for an advertised product or service, where the URL contains a unique identifier, such that individuals 104 visiting the website may be identified as having selected the URL presented in the advertisement 114 at the advertisement opportunity 116. As a second such example, the advertisement 114 may comprise a barcode, Quick Response (QR) code, or other machine-readable image that is associated with an advertised product or service, and a device or server that is provided to respond to user selection of such machine-readable images may determine that an individual 104 selected the image presented in the advertisement 114 at the advertisement opportunity 116. As a third such example, the product or service may be distinctively identified by the advertisement 114 presented at the advertisement opportunity 116, such as through a distinctive name or model number that is selectively utilized for the advertisement opportunity 116. The engagement of the individual 104 with the advertisement 104 may be detected through requests for information about the product or service including its distinctive identifier (e.g., web searches for a product according to a model number that is only used in the advertisement 114 at the advertisement opportunity). As a fourth such example, a device may detect a change of the behavior of the individual 104 following the presentation of the advertisement 114 at the advertisement opportunity 116, such as a change in the route 206 of the individual 104 toward a location 304 associated with the advertisement 114.

As a second variation of this fifth aspect, the detected engagement of the individual 104 with the advertisement 114 at the advertisement opportunity 116 may be used in various ways. As a first such example, the detected engagement may enable an assessment of the persuasiveness of the advertisement 114, particularly for individuals 104 having the shared demographic 308 of the individuals 104 to whom the advertisement 114 was presented. As a second such example, the detected engagement may enable an assessment of the visibility of the advertisement opportunity 116, e.g., by comparison with the effect of the same advertisement 114 presented at other advertisement opportunities 116. As a third such example, the detected engagement may enable a verification, refinement, or correction of the inference of the shared demographic 308 of the individuals 104 present at the advertisement opportunity 116, and/or of a demographics map 300 utilized in the inference. These and other uses of the engagement of the individuals 104 with the advertisement 114 when presented at the advertisement opportunity 116 may be included in implementations of the techniques presented herein.

D6. Additional Uses

A sixth aspect that may vary among embodiments of these techniques involves additional uses of the information about shared demographics 308 identified according to the techniques presented herein.

As a first variation of this sixth aspect, in addition to presenting targeted advertisements 520 at advertisement opportunities 116 to the individuals 104, the demographic information may be transmitted to notify at least one business provider near the travel region 102 of the advertisement opportunity 116 for advertisements 114 targeting the shared demographic 308 of the individuals 104 traveling in the travel region 102. For example, business owners along the route 206 may be interested in the shared demographics 308 of the traffic passing the business, and may be willing to pay for access to such information in order to target advertisements 114 for the business to the individuals 104.

As a second variation of this sixth aspect, the shared demographics 308 may be provided to entrepreneurs who may be interested in starting a business along the route 206 (e.g., in order to gauge the demand for products and services of such businesses according to the shared demographics 308 of individuals 102 traveling past the business).

As a third variation of this sixth aspect, the shared demographics may be transmitted to notify a selected individual 104 traveling in the travel area 102 of the shared demographics 308 that may be shared by the selected individual 104 with the other individuals 104 traveling near the selected individual. For example, bicyclists and airline passengers may be interested in learning the share demographics 308 of the nearby population. These and other uses of the shared demographics 308 may be devised by those of ordinary skill in the art while implementing the techniques presented herein.

### E. COMPUTING ENVIRONMENT

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 902 configured to implement one or more embodiments provided herein. In one configuration, computing device 902 includes at least one processing unit 906 and memory 908. Depending on the exact configuration and type of computing device, memory 908 may be volatile (such as RAM, for example), non-volatile (such as ROM, flash memory, etc., for example) or some combination of the two. This configuration is illustrated in FIG. 9 by dashed line 904.

In other embodiments, device 902 may include additional features and/or functionality. For example, device 902 may also include additional storage (e.g., removable and/or non-removable) including, but not limited to, magnetic storage, optical storage, and the like. Such additional storage is illustrated in FIG. 9 by storage 910. In one embodiment, computer readable instructions to implement one or more embodiments provided herein may be in storage 910. Storage 910 may also store other computer readable instructions to implement an operating system, an application program, and the like. Computer readable instructions may be loaded in memory 908 for execution by processing unit 906, for example.

The term “computer readable media” as used herein includes computer storage media. Computer storage media includes volatile and nonvolatile, removable and non-removable media implemented in any method or technology for storage of information such as computer readable instructions or other data. Memory 908 and storage 910 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 902. Any such computer storage media may be part of device 902.

Device 902 may also include communication connection(s) 916 that allows device 902 to communicate with other devices. Communication connection(s) 916 may include, but is not limited to, a modem, a Network Interface Card (NIC), an integrated network interface, a radio frequency transmitter/receiver, an infrared port, a USB connection, or other interfaces for connecting computing device 902 to other computing devices. Communication connection(s) 916 may include a wired connection or a wireless connection. Communication connection(s) 916 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 902 may include input device(s) 914 such as keyboard, mouse, pen, voice input device, touch input device, infrared cameras, video input devices, and/or any other input device. Output device(s) 912 such as one or more displays, speakers, printers, and/or any other output device may also be included in device 902. Input device(s) 914 and output device(s) 912 may be connected to device 902 via a wired connection, wireless connection, or any combination thereof. In one embodiment, an input device or an output device from another computing device may be used as input device(s) 914 or output device(s) 912 for computing device 902.

Components of computing device 902 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 902 may be interconnected by a network. For example, memory 908 may be comprised of multiple physical memory units located in different physical locations interconnected by a network.

Those skilled in the art will realize that storage devices utilized to store computer readable instructions may be distributed across a network. For example, a computing device 920 accessible via network 918 may store computer readable instructions to implement one or more embodiments provided herein. Computing device 902 may access computing device 920 and download a part or all of the computer readable instructions for execution. Alternatively, computing device 902 may download pieces of the computer readable instructions, as needed, or some instructions may be executed at computing device 902 and some at computing device 920.

### F. USAGE OF TERMS

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A nonvolatile computer-readable storage device comprising instructions that, when executed on a processor of a device, select advertisements for presentation at advertisement opportunities near travel regions traveled by individuals by:
for respective individuals traveling in a travel region having an advertisement opportunity:
identifying a route of the individual,
identifying at least one location visited by the individual along the route, and
based on the at least one location, identifying a demographic of the individual;
identifying a shared demographic of the individuals traveling in the travel region; and
selecting for presentation at the advertisement opportunity an advertisement targeting the shared demographic.

2. A system for presenting, using a device having a processor, advertisements at advertisement opportunities near travel regions traveled by individuals, the system comprising:
an individual tracking component configured to, for respective individuals traveling in a travel region having an advertisement opportunity:
identify a route of the individual, and
identify at least one location visited by the individual along the route;
a demographics mapping component configured to:
for respective individuals, based on the at least one location, identify a demographic of the individual; and
based on the demographics of the individuals, identify a shared demographic of the individuals traveling in the travel region; and
an advertisement selecting component configured to select for presentation at the advertisement opportunity an advertisement targeting the shared demographic.

3. A method of presenting, using a device having a processor, advertisements at advertisement opportunities near travel regions traveled by individuals, the method comprising:
executing on the processor instructions configured to:
for respective individuals traveling in a travel region having an advertisement opportunity:
identify a route of the individual,
identify at least one location visited by the individual along the route, and
based on the at least one location, identify a demographic of the individual;
identify a shared demographic of the individuals traveling in the travel region; and
select for presentation at the advertisement opportunity an advertisement targeting the shared demographic.

4. The method of claim 3:
the device having access to at least two communication devices respectively positioned at a location; and
identifying the route of the individual further comprising:
identifying at least two communication devices respectively communicating with the individual at a communication time; and
identifying the route from the communication times and the locations of the communication devices communicating with the individual.

5. The method of claim 3, the location visited by the individual having a location type selected from a location type set comprising:
a residence of the individual;
an employment place of the individual;
a commercial outlet visited by the individual;
an event site of an event attended by the individual; and
a neighborhood of a region including the location.

6. The method of claim 3:
the device having access to a demographics map identifying, for respective locations, a demographic of individuals associated with the location; and
identifying the demographic of a selected individual further comprising: using the demographics map, identifying a demographic of individuals associated with the location visited by the selected individual.

7. The method of claim 3, identifying the shared demographic further comprising: among the demographics of respective individuals traveling in the travel region, identify a dominant demographic shared by a significant portion of the individuals.

8. The method of claim 3:
identifying the route of the individual further comprising: detecting at least one device property of a device of respective individuals traveling in the travel region; and
identifying the demographic of the individual further comprising: identifying the demographic of the individual based on the at least one location visited by the individual along the route and the at least one device property of the devices of the individuals.

9. The method of claim 3:
identifying the route of the individual further comprising: detecting at least one device of the individuals traveling the travel region; and
selecting the advertisement further comprising: selecting for presentation at the advertisement opportunity an advertisement targeting the shared demographic and associated with at least one device of the individuals traveling in the travel region.

10. The method of claim 3, identifying the demographic of the user further comprising: receiving from the user a user selection of the demographic of the user.

11. The method of claim 3:
identifying the shared demographic further comprising: identifying a shared demographic of the individuals currently traveling in the travel region; and
the instructions further configured to present at least one selected advertisement to the individuals currently traveling in the travel region.

12. The method of claim 3:
the advertisement opportunity comprising at least two advertisement periods;
identifying the shared demographic further comprising: for respective advertisement periods, identifying a shared demographic of the individuals traveling in the travel region during the advertisement period; and
selecting the advertisement further comprising: selecting for presentation at the advertisement opportunity during the advertisement period at least one advertisement targeting the shared demographic of the individuals traveling in the travel region during the advertisement period.

13. The method of claim 12, selecting the advertisement opportunity further comprising: selecting for presentation at the advertisement opportunity an advertisement targeting the shared demographic and targeting the advertisement period.

14. The method of claim 3, selecting the advertisement opportunity further comprising: selecting for presentation at the advertisement opportunity an advertisement targeting the shared demographic and involving an advertised location near the routes of the individuals.

15. The method of claim 3, selecting the advertisement opportunity further comprising: selecting for presentation at the advertisement opportunity an advertisement targeting the shared demographic and associated with at least one of the locations visited by the individuals.

16. The method of claim 3:
identifying the shared demographic further comprising: for respective at least two advertisement opportunities respectively associated with a travel region, identify a shared demographic of the individuals traveling in the respective travel region; and
selecting the advertisement further comprising: for an advertisement targeting a demographic, selecting, among the at least two advertisement opportunities, the advertisement opportunity having a highest volume of individuals associated with the shared demographic.

17. The method of claim 3, selecting the advertisement further comprising:
identifying an advertiser of a product targeting a shared demographic of the advertisement opportunity associated with the shared demographic; and
receiving from the advertiser an advertisement targeting the shared demographic.

18. The method of claim 3:
the advertisement presented at the advertisement opportunity including a distinctive identifier; and
the instructions further configured to, upon receiving a request from an individual including the distinctive identifier, detect an engagement of the individual with the advertisement.

19. The method of claim 3, further comprising: notify at least one business provider near the travel region of the advertisement opportunity for advertisements targeting the shared demographic of the individuals traveling in the travel region.

20. The method of claim 3, further comprising: notifying at least one selected individual traveling in the travel region of the shared demographic of the individuals traveling in the travel region with the selected user.
